(19) United States
(12) Patent Application Publication
(10) Pub. No.: US 2020/0312050 A1
(43) Pub. Date: Oct. 1, 2020

(54) CONTROL DEVICE, SERVER, SAFETY SYSTEM, AND CONTROL METHOD OF CONTROL DEVICE

(71) Applicant: Keiichi Shimizu, Aichi (JP)

(72) Inventor: Keiichi Shimizu, Aichi (JP)

(73) Assignee: NIDEC MOBILITY CORPORATION, Aichi (JP)

(21) Appl. No.: 16/819,735

(22) Filed: Mar. 16, 2020

(30) Foreign Application Priority Data
Mar. 28, 2019 (JP) 2019-064690

(51) Int. Cl. G07C 5/00; H04W 4/44; G07C 5/08; G05B 13/02; G05B 13/04

(52) U.S. Cl. CPC G07C 5/008; H04W 4/44; G05B 13/048; G05B 13/0265; G07C 5/0816

(57) ABSTRACT

A control device collects vehicle data indicating at least one of a state of a vehicle, a state of a driver of the vehicle, and a situation around the vehicle; acquires determination data created based on at least a part of accident vehicle data as the vehicle data collected when an accident or an accident sign operation occurs in the past in a plurality of vehicles. The control device determines whether the vehicle is in a danger state based on the vehicle data and the determination data. The danger state is a state where the accident or the accident sign operation is likely to occur. The control device controls an operation of the vehicle or at least a part of various devices mounted on the vehicle in a case where it is determined that the vehicle is in a danger state.

### CROSS-REFERENCES TO RELATED APPLICATIONS

This application is based upon and claims the benefit of priority from Japanese Patent Application No. 2019-064690, filed on Mar. 28, 2019; the entire contents of which are incorporated herein by reference.

### FIELD

One or more embodiments of the present invention relate to a control device, a server, a safety system, and a control method of the control device.

### BACKGROUND

In a technique of extracting data from a vehicle in which a traffic accident or the like occurs and a technique of using the extracted data to analyze a cause of the accident, there have been various techniques so far. For example, JP-A-2016-71492 discloses a technique of estimating causes of an accident and a near-miss from a common feature between vehicle information transmitted from a vehicle and vehicle information accumulated by an accident and a near-miss which occurred in the past.

### SUMMARY

While there is a need to analyze a cause of an accident, there is also a need to prevent an accident. However, even when the technique described in JP-A-2016-71492 is applied, it is difficult to prevent an accident which will occur.

An object of one or more embodiments of the present invention is to realize a control device and the like capable of controlling a vehicle or a vehicle-mounted apparatus by detecting a state where an accident may occur in advance.

In one or more embodiments of the present invention, there is provided a control device including: a vehicle data collection unit that sequentially collects vehicle data from a vehicle-mounted device, the vehicle data which indicating at least one of a state of a vehicle, a state of a driver of the vehicle, and a situation around the vehicle; a determination data acquisition unit that acquires determination data, which is created based on at least a part of accident vehicle data as the vehicle data collected when an accident or an accident sign operation occurs in the past in a plurality of vehicles; a danger determination unit that sequentially determines whether or not the vehicle is in a danger state based on the vehicle data and the determination data, the danger state being a state where the accident or the accident sign operation is likely to occur; and an operation control unit that controls an operation of the vehicle or at least a part of various devices mounted on the vehicle in a case where it is determined that the vehicle is in a danger state.

According to the configuration, the danger determination unit sequentially determines whether or not the vehicle is in a danger state, from the determination data, which is based on at least a part of the vehicle data collected when an accident or an accident sign operation occurs, and the vehicle data sequentially collected by the vehicle. For example, while a state of the vehicle in traveling changes from moment to moment, according to the configuration, in a case where the vehicle enters a danger state, the danger state can be sequentially detected. In the case where the vehicle is in a danger state, it is possible to control an operation of the vehicle or the various devices. Therefore, according to the configuration, it is possible to detect a state where an accident may occur in advance and control the vehicle or a vehicle-mounted apparatus.

In the control device, the determination data may include data indicating a range of value of at least a part of parameters of the accident vehicle data, the range of value being a range in which the vehicle is estimated as being likely to enter the danger state. Further, the danger determination unit may determine that the vehicle is in the danger state in a case where a value of a parameter of the vehicle data is included in the range of value.

According to the configuration, in a case where values of specific parameters of the vehicle data are included in the ranges of the values of the same parameters of the determination data, the ranges being ranges in which the vehicle is estimated as “being likely to enter a danger state”, the control device determines that the vehicle is in a danger state. Therefore, it is possible to more accurately determine whether or not the vehicle is in a danger state.

In the control device, the danger determination unit may determine whether or not the vehicle is in the danger state according to, among the parameters of the vehicle data, a number of parameters of the vehicle data each having a value included in the range of value of the same parameter of the determination data.

A fact that values of certain parameters of the vehicle data are included in the ranges of the values of the same parameters of the determination data means that the vehicle is estimated as “being likely to enter a danger state” from the values of the parameters of the vehicle data. Therefore, by determining whether or not the vehicle is in a danger state according to, among the parameters of the vehicle data, the number of the parameters of which the values are included in the ranges of the values of the same (corresponding) parameters of the determination data, it is possible to accurately determine whether or not the vehicle is in a danger state.

In the control device, the determination data may be a prediction model, which is created based on a learned model obtained by inputting at least a part of parameters of the accident vehicle data and performing machine learning of a value of the at least a part of parameters when the accident or the accident sign operation occurs. Further, the danger determination unit may determine whether or not the vehicle is in the danger state based on a matching rate of values of the parameters included in the vehicle data when the values are input to the prediction model.

According to the configuration, by inputting values of certain parameters included in the vehicle data to the prediction model, it is possible to determine whether or not the vehicle is in a danger state from the prediction model. Therefore, it is possible to accurately determine whether or not the vehicle is in a danger state from the vehicle data.

In the control device, the operation control unit may notify the driver that the vehicle is in the danger state by causing an output device of the various devices to perform outputting.

According to the configuration, it is possible to notify the driver that the vehicle is in a danger state. Therefore, the driver can be alerted, and thus the driver can more safely drive the vehicle.

In the control device, the operation control unit may control, as the operation of the vehicle or at least a part of the various devices mounted on the vehicle, an operation of the vehicle or the various devices executed in response to a manipulation related to driving of the driver.

According to the configuration, in a case where the vehicle is in a danger state, the operation control unit controls an operation of the vehicle or the various devices, the operation being executed in response to driving. Thereby, it is possible to detect a state where an accident may occur in advance, and control an operation of the vehicle or a vehicle-mounted apparatus, the operation being related to driving.

The control device may further include a personal data collection unit that collects personal data related to an individual driver. Further, the determination data may be created based on at least a part of the personal data, and the danger determination unit may sequentially determine whether or not the vehicle is in the danger state based on the vehicle data, the personal data, and the determination data.

According to the configuration, the data related to the individual driver can be considered in creation of the determination data. Further, whether or not the vehicle is in a danger state is sequentially determined from the personal data, the vehicle data, and the determination data. Therefore, it is possible to determine whether or not the vehicle is in a danger state in consideration of individuality of each driver. Thereby, it is possible to improve accuracy of determination as to whether or not the vehicle is in a danger state.

The control device may further include: a danger operation detection unit that detects, as a danger operation, a specific behavior of the vehicle or the driver indicating the accident or the accident sign operation; and a transmission unit that transmits, to a server, the accident vehicle data obtained by extracting at least a part of the vehicle data in a case where the danger operation is detected. Further, the determination data acquisition unit may acquire the determination data created by the server.

According to the configuration, the accident vehicle data when an accident or an accident sign operation occurs in the vehicle can be used for creation of the determination data. Thereby, the determination data can be sequentially updated. Therefore, it is possible to improve accuracy of determination as to whether or not the vehicle is in a danger state.

In one or more embodiments of the present invention, there is provided a server that performs communication with the control device, the server including: a server reception unit that receives the accident vehicle data; a determination data creation unit that creates the determination data based on at least a part of the accident vehicle data; and a server transmission unit that transmits the determination data to the control device. According to the configuration, it is possible to obtain the same effects as effects of the control device.

In one or more embodiments of the present invention, there is provided a safety system including the control device and the server. According to the configuration, it is possible to obtain the same effects as effects of the control device.

In one or more embodiments of the present invention, there is provided a control method of a control device, the control method including: sequentially collecting vehicle data from a vehicle-mounted device, the vehicle data indicating at least one of a state of a vehicle, a state of a driver of the vehicle, and a situation around the vehicle; creating determination data based on at least a part of accident vehicle data as the vehicle data collected when an accident or an accident sign operation occurs in the past in a plurality of vehicles; sequentially determining whether or not the vehicle is in a danger state based on the vehicle data and the determination data, the danger state being a state where the accident or the accident sign operation is likely to occur; and controlling an operation of at least a part of the vehicle in a case where it is determined that the vehicle is in a danger state. According to the configuration, it is possible to obtain the same effects as effects of the control device.

According to one or more embodiments of the present invention, it is possible to detect a state where an accident may occur in advance and control the vehicle or a vehicle-mounted apparatus.

### BRIEF DESCRIPTION OF DRAWINGS

FIGS. 1A and 1B are diagrams illustrating an outline of a safety system according to an embodiment 1 of the present invention.

FIG. 2 is a block diagram illustrating an example of a configuration of a main part of the safety system.

FIG. 3 is a flowchart illustrating an example of a flow of processing in a case where an accident or a near-miss occurs in a certain vehicle.

FIG. 4 is a flowchart illustrating an example of a flow of danger determination processing.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

### Embodiment 1

### Outline of System

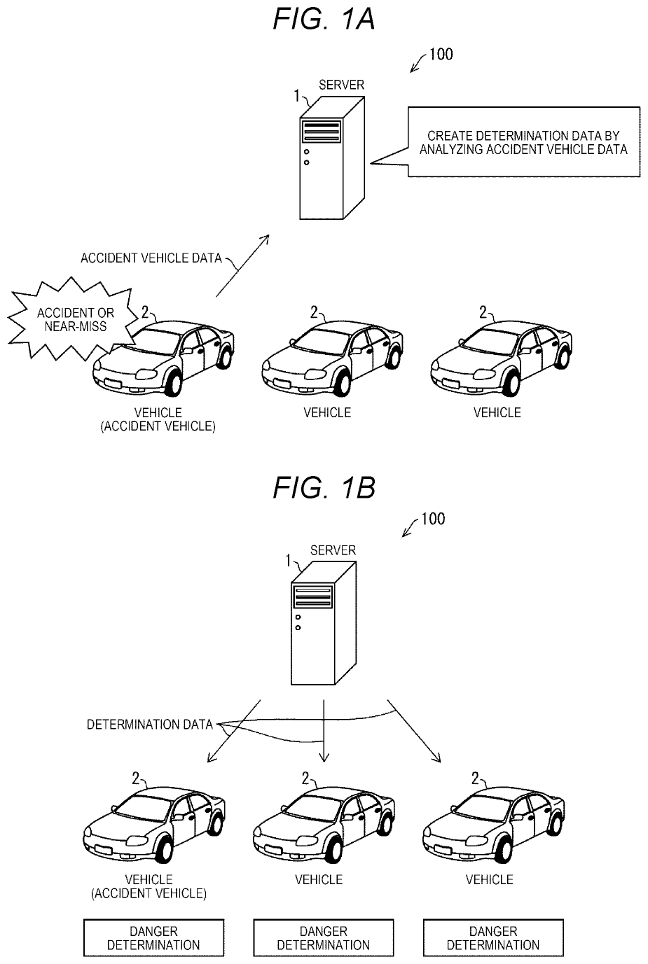

Hereinafter, an embodiment 1 of the present invention will be described with reference to FIGS. 1A to 4. FIGS. 1A and 1B are diagrams schematically illustrating an outline of an operation of a safety system 100 according to the present embodiment. The safety system 100 is a system for preventing an accident of a vehicle. The safety system 100 includes a server 1 and a control device. In the present embodiment, the control device is realized by, for example, an integrated engine control unit (ECU) 4 of a vehicle 2. The integrated ECU 4 will be described in detail below.

The safety system 100 mainly performs two pieces of processing. First processing is processing of, when an accident or a near-miss occurs in a certain vehicle 2, collecting data indicating at least one of a state of the vehicle 2, a state of a driver of the vehicle 2, or a situation around the vehicle 2, from the vehicle 2. Second processing is processing in which each vehicle 2 acquires determination data, which is created based on the data by the server 1, and performs danger determination using the determination data.

In the present embodiment, “near-miss” indicates an operation which does not cause an accident but may cause an accident. In other words, the near-miss in the present embodiment is an accident sign operation. Hereinafter, a vehicle 2 in which an accident or a near miss occurs is also referred to as an “accident vehicle”. In addition, in the present embodiment, the “danger determination” indicates determination as to whether or not a certain vehicle 2 is in a state in which an accident or a near-miss may occur. Hereinafter, the state in which an accident or a near-miss may occur is also referred to as a “danger state”.

Further, in the present embodiment, data indicating at least one of a state of a vehicle, a state of a driver of the vehicle, or a situation around the vehicle is referred to as “vehicle data”. The vehicle data collected in the accident vehicle when an accident or an accident sign operation occurs in the past is referred to as “accident vehicle data”.

FIG. 1A illustrates an outline of an operation of the safety system 100 in a case where an accident or a near-miss occurs in a certain vehicle 2. In the safety system 100, the integrated ECU 4 of the vehicle 2 sequentially collects the vehicle data. The vehicle data includes, for example, measurement data of a device mounted on the vehicle 2.

The integrated ECU 4 of the accident vehicle detects that an accident or a near-miss occurs. For example, the integrated ECU 4 of the accident vehicle detects a specific behavior of the own vehicle or a driver of the own vehicle in which an accident or a near-miss occurs or is likely to occur. Hereinafter, the specific behavior is referred to as a “danger operation”. Examples of the danger operation include, for example, applying a sudden brake, turning a steering wheel suddenly, operating an air bag, and the like.

When the integrated ECU 4 detects a danger operation, the vehicle extracts the vehicle data, which is collected within a predetermined period from a reference time when the danger operation occurs, and transmits the extracted vehicle data to the server 1, as accident vehicle data. When the server 1 receives the accident vehicle data, the server 1 creates determination data based on the received accident vehicle data. The determination data is data used as a determination criterion in the danger determination in the vehicle 2.

FIG. 1B illustrates an outline of an operation of the safety system 100 in a case where the danger determination is performed in each vehicle 2. The server 1 transmits the determination data to each vehicle 2. A transmission timing of the determination data is not particularly limited. For example, the server 1 may transmit the determination data when a request is received from the vehicle 2, or may transmit the determination data at a predetermined time interval such as once a day. The integrated ECU 4 of the vehicle 2 acquires the determination data from the server 1. As illustrated in FIG. 1B, the accident vehicle may also acquire the determination data similarly to the other vehicles 2.

The integrated ECU 4 of the vehicle 2 performs danger determination of the own vehicle based on the collected vehicle data and the determination data. Details of the danger determination will be described below. In a case where the integrated ECU 4 determines that the own vehicle is in a danger state, the integrated ECU 4 controls an operation of the own vehicle or at least a part of various devices mounted on the own vehicle. For example, in a case where the integrated ECU 4 determines that the own vehicle is in a danger state, the integrated ECU 4 turns on an alert lamp or performs steering reaction control.

As described above, the safety system 100 collects the accident vehicle data from the accident vehicle, distributes the determination data based on the accident vehicle data to each of the vehicles 2 including the accident vehicle, and causes the vehicle 2 to perform the danger determination and a control of an operation of the vehicle 2 according to a result of the danger determination. Thereby, the safety system 100 can detect a state where an accident may occur in advance, and control the vehicle or various devices of the vehicle.

### Configuration of Main Part

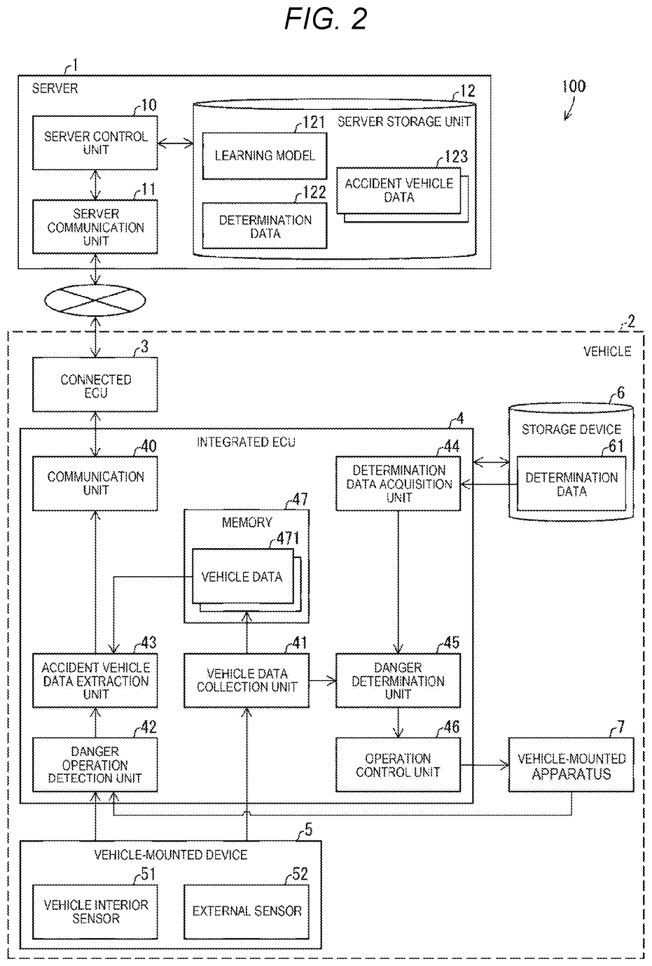

FIG. 2 is a diagram illustrating a configuration of a main part of the safety system 100. The safety system 100 includes one or more servers 1 and one or more control devices. In the example illustrated in FIG. 2, the control device is realized as an integrated ECU 4 mounted on the vehicle 2. In FIG. 2, as an example, the safety system 100 including one server 1 and one vehicle 2 is illustrated. On the other hand, the number of the servers 1 and the number of the vehicles 2 included in the safety system 100 are not particularly limited.

(Server 1)

The server 1 is an apparatus that performs communication with the integrated ECU 4 of the vehicle 2, collects the accident vehicle data from the integrated ECU 4, and accumulates the collected accident vehicle data. Further, the server 1 is an apparatus that creates determination data from the accident vehicle data. The server 1 includes a server control unit (determination data creation unit) 10, a server communication unit (server reception unit, server transmission unit) 11, and a server storage unit 12.

The server communication unit 11 is a communication interface of the server 1. The server communication unit 11 receives the accident vehicle data from the integrated ECU 4 of the vehicle 2. The server communication unit 11 outputs the received accident vehicle data to the server control unit 10. In addition, the server communication unit 11 transmits the determination data, which is input from the server control unit 10, to the integrated ECU 4 of the vehicle 2.

The server control unit 10 overall controls the server 1. For example, the server control unit 10 acquires the accident vehicle data from the integrated ECU 4 via the server communication unit 11. The server control unit 10 stores the acquired accident vehicle data in the server storage unit 12, as accident vehicle data 123. In addition, the server control unit 10 creates determination data based on at least a part of the accident vehicle data 123 stored in the server storage unit 12.

A method of creating the determination data by the server control unit 10 and a data structure of the created determination data are not particularly limited. For example, the server control unit 10 may perform machine learning of values of at least some parameters of the accident vehicle data when an accident or a near-miss occurs by inputting the parameters to a learning model 121 of the server storage unit 12. Then, the server control unit 10 may create the determination data based on the learning model 121 obtained by performing machine learning, that is, a learned model.

In this case, for example, the server control unit 10 may create a prediction model, which receives values of at least some parameters of the vehicle data and outputs, as the determination data, matching rates with values of the same parameters when a danger operation occurs, that is, when an accident or a near-miss occurs.

In addition, by analyzing the accident vehicle data (accident vehicle data 123) accumulated in the server storage unit 12 using a predetermined algorithm, the server control unit 10 may specify ranges of values of at least some parameters of the accident vehicle data, the ranges being ranges in which the vehicle is estimated as being likely to enter a danger state. Data indicating the ranges of the values may be used as the determination data.

The server storage unit 12 stores various data related to the server 1. The server storage unit 12 includes a learning model 121, determination data 122, and accident vehicle data 123. In the server 1 according to the present embodiment, the learning model 121 is not an essential component. For example, in a case where the server control unit 10 does not use the learning model 121 when creating the determination data, the server storage unit 12 may not store the learning model 121.

The learning model 121 is a learning model used for creating the prediction model. A learning algorithm of the learning model 121 and parameters used for the learning are not particularly limited as long as the learning model can create the prediction model as the determination data.

The determination data 122 is determination data created by the server control unit 10. The accident vehicle data 123 is accident vehicle data acquired by the server control unit 10 via the server communication unit 11. The accident vehicle data 123 acquired by the server communication unit 11 from each vehicle 2 is accumulated in the server storage unit 12.

(Connected ECU 3)

A connected ECU 3 is a gateway that connects an internal network of the vehicle 2 and an external network (Internet) of the vehicle 2. In the safety system 100, in a case where the integrated ECU 4 can be connected to the Internet and perform direct communication with the server 1 while ensuring security, the connected ECU 3 is not an essential component.

(Integrated ECU 4)

The integrated ECU 4 is a control device for electronically controlling each unit of the vehicle 2. The integrated ECU 4 includes a communication unit (transmission unit) 40, a vehicle data collection unit 41, a danger operation detection unit 42, an accident vehicle data extraction unit 43, a determination data acquisition unit 44, a danger determination unit 45, and an operation control unit 46.

The communication unit 40 is a communication interface of the integrated ECU 4. The communication unit 40 transmits the accident vehicle data inputted from the accident vehicle data extraction unit 43, to the server 1 via the connected ECU 3. In addition, the communication unit 40 receives the determination data from the server 1 via the connected ECU 3.

The vehicle data collection unit 41 sequentially collects vehicle data from a vehicle-mounted device 5. The vehicle data collection unit 41 stores the collected vehicle data in a memory 47, as vehicle data 471. The vehicle data collection unit 41 may actively acquire vehicle data from the vehicle-mounted device 5, or may passively acquire vehicle data from the vehicle-mounted device 5.

The danger operation detection unit 42 detects a danger operation. A type of the danger operation and a detection method of the danger operation are not particularly limited. For example, the danger operation detection unit 42 may detect a danger operation based on vehicle data acquired from the vehicle-mounted device 5, data acquired from a vehicle-mounted apparatus 7 and indicating a state of each vehicle-mounted apparatus 7, or the like. In a case where a danger operation is detected, the danger operation detection unit 42 notifies the accident vehicle data extraction unit 43 that a danger operation is detected.

More specifically, for example, the danger operation detection unit 42 may sequentially receive data indicating a degree of application of a brake as the vehicle-mounted apparatus 7, from a control device of the brake. In a case where the brake is applied with strength of a certain level or higher, that is, in a case where the driver applies a sudden brake, the danger operation detection unit 42 may detect the sudden brake as the danger operation. Further, for example, the danger operation detection unit 42 may sequentially receive data indicating an angle of a steering wheel as the vehicle-mounted apparatus 7, from a control device of the steering wheel. In a case where the steering wheel is turned at a certain angle or more, that is, in a case where the driver suddenly and greatly manipulates the steering wheel, the danger operation detection unit 42 may detect the sudden turning of the steering wheel, as the danger operation.

In addition, the danger operation detection unit 42 may indirectly detect that a danger operation occurs. For example, the danger operation detection unit 42 may sequentially receive data indicating whether or not an airbag as the vehicle-mounted apparatus 7 is inflated, from a control device of the airbag. In a case where the airbag is inflated, the danger operation detection unit 42 may detect the operation as the danger operation.

Alternatively, the danger operation detection unit 42 may sequentially receive data indicating whether or not an alarm is transmitted, from a control device of a speaker. In a case where an alarm is transmitted, the danger operation detection unit 42 may detect the operation as the danger operation. In addition, in a case where data indicating strong shaking, impact, or the like with respect to a vehicle body of the vehicle 2 is received from the vehicle-mounted device 5, the danger operation detection unit 42 may detect the operation as the danger operation.

In a case where the danger operation is detected, the accident vehicle data extraction unit 43 creates accident vehicle data from which at least a part of the vehicle data is extracted, and transmits the created accident vehicle data to the server 1 via the communication unit 40. When detection of the danger operation is notified from the danger operation detection unit 42, the accident vehicle data extraction unit 43 extracts at least a part of the vehicle data stored in the memory 47, specifically, the vehicle data in a predetermined period. The accident vehicle data extraction unit 43 outputs the accident vehicle data to the communication unit 40.

Here, the vehicle data in the predetermined period may be, for example, in a case where a time when the danger operation occurs is set as a start time, vehicle data from the start time to a time before the predetermined period. In addition, the vehicle data in the predetermined period may be, for example, in a case where a time when the danger operation occurs is set as a start time, vehicle data from the start time to a time after the predetermined period. Further, the vehicle data in the predetermined period may be, for example, in a case where a time when the danger operation occurs is set as a start time, vehicle data in the predetermined period including the start time.

The determination data acquisition unit 44 acquires the determination data from the storage device 6. The determination data acquisition unit 44 outputs the acquired determination data to the danger determination unit 45. The determination data acquisition unit 44 may directly acquire the determination data from the server 1 via the communication unit 40.

The danger determination unit 45 sequentially determines whether or not the vehicle 2 is in a danger state based on the vehicle data and the determination data. The danger determination unit 45 notifies the operation control unit 46 of the determination result. A method of the danger determination in the danger determination unit 45 is not particularly limited. The danger determination unit 45 may determine a method of the danger determination according to, for example, a data structure or a characteristic of the determination data.

For example, it is assumed that the determination data is data indicating ranges of values of at least some parameters of the accident vehicle data, the ranges being ranges in which the vehicle is estimated as being likely to enter a danger state. In this case, in a case where values of parameters of the vehicle data are included in the ranges of the values of the same parameters of the determination data, the danger determination unit 45 may determine that the vehicle 2 is in a danger state.

Thereby, in a case where values of specific parameters of the vehicle data are included in the ranges of the values of the same parameters of the determination data, the ranges being ranges in which the vehicle is estimated as “being likely to enter a danger state”, the danger determination unit 45 determines that the vehicle 2 is in a danger state. Therefore, it is possible to more accurately determine whether or not the vehicle 2 is in a danger state.

In other words, the danger determination unit 45 may determine whether or not the vehicle 2 is in a danger state according to, among the parameters of the vehicle data, the number of the parameters of which the values are included in the ranges of the values of the same parameters of the determination data. For example, the danger determination unit 45 may specify, with respect to the total number of parameters of the determination data, among the parameters of the vehicle data, the number of the same parameters of which the values are included in the ranges of the values of the parameters of the determination data, and determine that the vehicle 2 is in a danger state in a case where the number of the same parameters of the vehicle data is equal to or larger than a predetermined value. In other words, in a case where, in the total number of the parameters of the vehicle data, a ratio of the parameters of which the values are included in the ranges of the values of the corresponding parameters of the determination data is equal to or greater than a predetermined value, the danger determination unit 45 may determine that the vehicle 2 is in a danger state.

A fact that values of certain parameters of the vehicle data are included in the ranges of the values of the same parameters of the determination data means that the vehicle is estimated as “being likely to enter a danger state” from the values of the parameters of the vehicle data. Therefore, by determining whether or not the vehicle 2 is in a danger state according to, among the parameters of the vehicle data, the number of the parameters of which the values are included in the ranges of the values of the same parameters of the determination data, it is possible to more accurately determine whether or not the vehicle 2 is in a danger state.

Further, for example, it is assumed that the determination data is a prediction model, which is created based on a learned model obtained by performing machine learning of values of at least some parameters of the accident vehicle data when an accident or an accident sign operation occurs by inputting the parameters to a learning model. In this case, the danger determination unit 45 may obtain matching rates of the values of the parameters when the values of the parameters included in the vehicle data are input to the determination data (prediction model). The danger determination unit 45 may determine whether or not the vehicle 2 is in a danger state based on the matching rates. For example, in a case where the matching rates are equal to or larger than a predetermined threshold value, the danger determination unit 45 may determine that the vehicle 2 is in a danger state.

Thereby, by inputting values of certain parameters included in the vehicle data to the prediction model, it is possible to perform danger determination using the prediction model. Therefore, it is possible to accurately determine whether or not the vehicle is in a danger state from the vehicle data.

The operation control unit 46 controls an operation of the own vehicle 2 or at least a part of the vehicle-mounted apparatuses 7. In a case where the danger determination unit 45 notifies the operation control unit 46 that the vehicle 2 is in a danger state as a determination result, the operation control unit 46 controls an operation of the vehicle 2 or at least a part of the vehicle-mounted apparatuses 7.

For example, the operation control unit 46 may notify the driver that the vehicle 2 is in a danger state by causing an output device as the vehicle-mounted apparatuses 7 to output the fact. More specifically, the operation control unit 46 may notify the driver that the vehicle 2 is in a danger state by outputting a sound warning from a speaker, lighting an alert lamp, or displaying a warning image on a display. In addition, the operation control unit 46 may notify the driver that the vehicle 2 is in a danger state by vibrating a vibrator as the vehicle-mounted apparatuses 7 which is provided on a seat surface of a driver's seat, a steering wheel, or the like.

In this way, the driver is notified that the vehicle 2 is in a danger state, and thus the driver can be alerted. Therefore, the vehicle 2 can be driven more safely.

In addition, the operation control unit 46 may control an operation of the vehicle 2 or the vehicle-mounted apparatus 7, as an operation of the vehicle 2 or at least a part of the vehicle-mounted apparatuses 7, the operation being executed in response to a manipulation related to driving of the driver.

For example, in a case where the vehicle 2 is a vehicle that performs partial automatic driving, the operation control unit 46 may increase a proportion of manual driving of the driver by lowering a level of automatic driving of the own vehicle 2. Alternatively, the operation control unit 46 may change an automatic driving mode to a driving mode for performing safer driving by controlling an operation of a control device that controls automatic driving of the vehicle 2. Examples of the driving mode for performing safer driving include, for example, a mode in which reaction control is performed such that sudden steering control is not performed and a mode in which control is changed such that a speed of the vehicle gradually increases at a constant rate even when sudden accelerator work is performed.

As described above, in a case where the vehicle 2 is in a danger state, the operation control unit 46 can control an operation of the vehicle 2 or the vehicle-mounted apparatus 7, the operation being executed in response to driving. Thereby, the integrated ECU 4 can detect a state where an accident may occur in advance, and control an operation of the vehicle 2 or the vehicle-mounted apparatus 7, the operation being related to driving.

(Vehicle-mounted Device 5)

The vehicle-mounted device 5 is a device for acquiring vehicle data. One or more vehicle-mounted devices 5 are mounted on the vehicle 2. In the example illustrated in FIG. 2, as the vehicle-mounted device 5, a vehicle interior sensor 51 and an external sensor 52 are mounted on the vehicle 2.

The vehicle interior sensor 51 is a sensor or a sensor group for measuring data related to a state of the vehicle interior or a state of the driver. The vehicle interior sensor 51 may be, for example, a camera that captures an image of a face of the driver, an electric wave sensor or a capacitance sensor for measuring a pulse rate or respiration of the driver, a behavior monitor for detecting a behavior of the driver, or the like.

The external sensor 52 is a sensor or a sensor group for measuring data related to a situation around the vehicle 2. The situation around the vehicle 2 indicates, for example, an obstacle existing around the vehicle 2, a shape of a road around the vehicle 2, a position and movement of another vehicle around the vehicle 2, weather around the vehicle 2, and the like. The external sensor 52 may be, for example, a light detection and ranging (LiDAR), an ADAS camera, a raindrop sensor, a millimeter-wave radar, an ultrasonic-wave radar, or the like.

The vehicle-mounted device 5 transmits the acquired vehicle data to the vehicle data collection unit 41. In addition, the vehicle-mounted device 5 may transmit the acquired vehicle data to the danger operation detection unit 42.

The vehicle-mounted device 5 is not limited to a sensor. For example, the vehicle-mounted device 5 may include a receiving device that receives V2V information, which is information from another vehicle 2. Further, the vehicle-mounted device 5 may include a receiving device that receives V2I information such as traffic congestion information of a traffic light or a road. The vehicle-mounted device 5 may transmit the V2V information or the V2I information to the vehicle data collection unit 41 and the danger operation detection unit 42, as vehicle data.

(Storage Device 6)

The storage device 6 is a storage unit for storing various data used by the integrated ECU 4. The storage device 6 stores determination data 61. The determination data 61 is determination data received from the server 1 by the integrated ECU 4.

(Vehicle-mounted Apparatus 7)

The vehicle-mounted apparatus 7 includes various devices mounted on a vehicle. Examples of the vehicle-mounted apparatus 7 include a speaker, an alert lamp, various devices of a car navigation system, a display, an air conditioner, a vibrator, and the like. The vehicle-mounted apparatus 7 operates under the control of the operation control unit 46.

### Flow of Processing in Occurrence of Accident

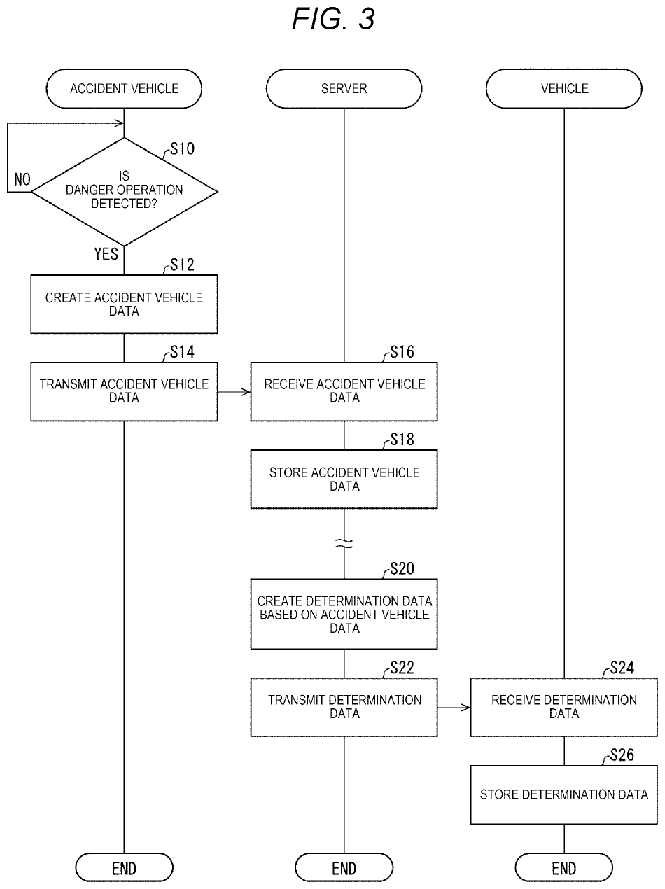

FIG. 3 is a flowchart illustrating an example of a flow of processing in a case where an accident or a near-miss occurs in a certain vehicle 2. The danger operation detection unit 42 of the accident vehicle monitors whether or not the vehicle 2 or the driver performs a danger operation (NO in S10). In a case where an accident or a near-miss occurs, the danger operation detection unit 42 detects a danger operation (YES in S10). The danger operation detection unit 42 notifies the accident vehicle data extraction unit 43 that a danger operation is detected.

When the notification is received, the accident vehicle data extraction unit 43 reads the vehicle data 471 stored in the memory 47, and creates accident vehicle data based on the vehicle data 471 (S12). The accident vehicle data extraction unit 43 outputs the created accident vehicle data to the communication unit 40. The communication unit 40 transmits the accident vehicle data to the server 1 (S14).

The server communication unit 11 of the server 1 receives the accident vehicle data (S16). The server communication unit 11 outputs the accident vehicle data to the server control unit 10. When the accident vehicle data is input, the server control unit 10 stores the accident vehicle data in the server storage unit 12, as accident vehicle data 123 (S18).

In a case where processing up to S18 is completed between at least one accident vehicle and the server 1, the server control unit 10 of the server 1 creates determination data based on the accident vehicle data 123 at a certain timing after step S18 (S20). The server control unit 10 stores the created determination data in the server storage unit 12, as determination data 122.

Thereafter, at a certain timing, the server control unit 10 reads at least a part of the determination data 122 stored in the server storage unit 12, as determination data to be transmitted to each vehicle 2. The server control unit 10 outputs the read determination data to the server communication unit 11. The server communication unit 11 transmits the determination data to the integrated ECU 4 (S22).

The communication unit 40 of the integrated ECU 4 receives the determination data (S24). The integrated ECU 4 stores the received determination data in the storage device 6, as determination data 61.

According to the above-described processing, the accident vehicle data when an accident or an accident sign operation occurs in the accident vehicle can be used for creation of the determination data. Thereby, the determination data in the server 1 can be sequentially updated. The server 1 can transmit the updated determination data to each vehicle 2. Therefore, the vehicle 2 can improve accuracy of danger determination.

### Flows of Danger Determination Processing and Operation Control after Determination

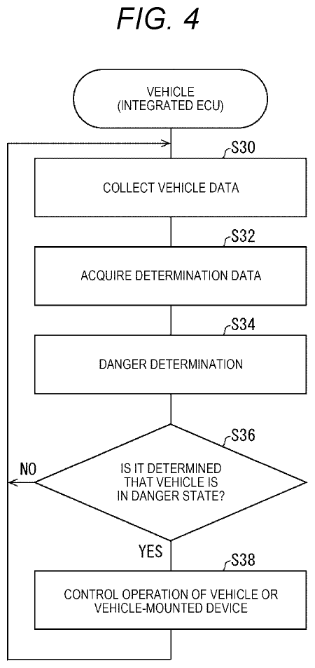

FIG. 4 is a flowchart illustrating an example of a flow of processing (danger determination processing) related to danger determination in the integrated ECU 4. The vehicle data collection unit 41 of the integrated ECU 4 collects vehicle data from the vehicle-mounted device 5 (S30). The vehicle data collection unit 41 stores the collected vehicle data in the memory 47. Further, the vehicle data collection unit 41 outputs the collected vehicle data to the danger determination unit 45.

The determination data acquisition unit 44 acquires determination data 61 stored in the storage device 6 (S32). The determination data acquisition unit 44 outputs the acquired determination data 61 to the danger determination unit 45. The danger determination unit 45 performs danger determination based on the input vehicle data and the determination data (S34). The danger determination unit 45 outputs a result of the danger determination to the operation control unit 46.

As a result of the danger determination, in a case where it is determined that the vehicle 2 is not in a danger state (NO in S36), the operation control unit 46 does not perform any particular operation control. On the other hand, in a case where it is determined that the vehicle 2 is in a danger state (YES in S36), the operation control unit 46 controls an operation of the vehicle 2 or at least a part of the vehicle-mounted apparatuses 7 (S38). When the vehicle data collection unit 41 collects next vehicle data (S30), the integrated ECU 4 performs again the processing of step S32 and subsequent steps.

According to the above-described processing, it is possible to sequentially determine whether or not the vehicle 2 is in a danger state, from the determination data based on at least a part of the vehicle data, which is collected when an accident or an accident sign operation occurs, and the vehicle data sequentially collected by the vehicle 2. For example, while a state of the vehicle 2 in traveling changes from moment to moment, the danger determination is sequentially performed. Thus, in a case where the vehicle 2 enters a danger state, the danger state can be sequentially detected. In the case where the vehicle 2 is in a danger state, it is possible to control an operation of the vehicle 2 or the vehicle-mounted apparatus 7. Therefore, according to the configuration, it is possible to detect a state where an accident may occur in advance and control the vehicle or the vehicle-mounted apparatus.

### Embodiment 2

An embodiment 2 of the present invention will be described below. For convenience of description, members having the same functions as those described in the above-described embodiment are denoted by the same reference numerals, and a description thereof will not be repeated.

The integrated ECU 4 of the safety system 100 may include a personal data collection unit that collects personal data as data related to an individual driver. In addition, the server control unit 10 of the server 1 may create determination data based on at least a part of the personal data, and transmit the determination data to the integrated ECU 4. That is, the determination data used for danger determination in the vehicle 2 may be created based on at least a part of the personal data. Further, the danger determination unit 45 may perform danger determination based on the vehicle data, the personal data, and the determination data.

The integrated ECU 4 according to the present embodiment collects personal data, which is data related to an individual driver of the vehicle 2, from the vehicle-mounted device 5, the vehicle-mounted apparatus 7, or an external apparatus of the vehicle 2 via a network.

For example, the integrated ECU 4 may collect, as personal data, personal information of a driver, who is registered in a car navigation system, from the device of the car navigation system as the vehicle-mounted apparatus 7. In addition, the integrated ECU 4 may collect, as personal data, personal information that a user inputs to a touch panel or the like as the vehicle-mounted apparatus 7. Alternatively, the integrated ECU 4 may collect, as personal data, information related to an insurance for the vehicle 2 from a server of an insurance company via a network. The integrated ECU 4 stores the collected personal data in the storage device 6. Further, the integrated ECU 4 may transmit the personal data to the server 1.

When creating determination data, the server control unit 10 of the server 1 may create determination data according to the personal data received from the integrated ECU 4. For example, the server control unit 10 may classify pieces of personal data received from a plurality of vehicles 2 into clusters according to a degree of similarity or the like, and may create determination data for each of the clusters. In this case, preferably, the server control unit 10 creates determination data in consideration of the content of the personal data in the same cluster.

For example, in a case where a driving history can be determined from the personal data, the server control unit 10 may create pieces of determination data for a plurality of clusters, according to a period of the driving history, for example, a driving history shorter than one year, a driving history equal to or longer than one year and shorter than five years, a driving history equal to or longer than five years, or the like. In a case where the personal data is received from the integrated ECU 4 of a certain vehicle 2, the server control unit 10 may store the personal data in the server storage unit 12, specify a cluster to which the personal data belongs, and transmit the determination data corresponding to the cluster to the integrated ECU 4 of the certain vehicle 2. For example, the server control unit 10 may return the determination data for the cluster of which the driving history is shorter than one year, to the integrated ECU 4 from which the personal data indicating that the driving history is shorter than one year is transmitted.

Further, in danger determination, the danger determination unit 45 of the integrated ECU 4 may perform danger determination based on the personal data, the vehicle data, and the determination data. For example, in a case where it is specified that the driving history is shorter than one year based on the personal data, the danger determination unit 45 may relax a condition for determining whether the vehicle is in a danger state, as compared with a case where the driving history is equal to or longer than one year and shorter than five years. On the other hand, in a case where the driving history is equal to or longer than five years, the danger determination unit 45 may strengthen a condition for determining whether the vehicle is in a danger state, as compared with a case where the driving history is equal to or longer than one year and shorter than five years.

According to the configuration, the data related to the individual driver can be considered in creation of the determination data. Further, whether or not the vehicle is in a danger state is sequentially determined from the personal data, the vehicle data, and the determination data. Therefore, it is possible to determine whether or not the vehicle is in a danger state in consideration of individuality of each driver. Thereby, it is possible to improve accuracy of determination as to whether or not the vehicle is in a danger state.

### Modification Example

The integrated ECU 4 of the safety system 100 does not have functions of creating and transmitting accident vehicle data, and may have a function of danger determination. Further, the integrated ECU 4 of the safety system 100 does not have a function of danger determination, and may have functions of creating and transmitting accident vehicle data.

In a case where the integrated ECU 4 does not have functions of creating and transmitting accident vehicle data and has a function of danger determination, the integrated ECU 4 may not include the danger operation detection unit 42 and the accident vehicle data extraction unit 43.

In addition, in a case where the integrated ECU 4 does not have a function of danger determination and has functions of creating and transmitting accident vehicle data, the integrated ECU 4 may not include the determination data acquisition unit 44, the danger determination unit 45, and the operation control unit 46.

Further, in a case where a life of the memory 47, that is, a life for which the memory 47 can temporarily store data, is passed, the integrated ECU 4 may not perform functions of creating and transmitting accident vehicle data, and may perform a function of danger determination. Thereby, even in a vehicle with which a certain time has elapsed from manufacture, such as a used vehicle, determination processing using the determination data can be executed. On the other hand, the determination data is updated from the server 1. Therefore, even in an old vehicle, danger determination can be performed using the latest determination data.

In addition, the integrated ECU 4 may store a history of a result of the danger determination in the storage device 6. For example, the integrated ECU 4 may create log data in which the result of the danger determination in the danger determination unit 45 is associated with the date and time, and store the log data in the storage device 6. Alternatively, in a case where it is determined that the vehicle 2 is in a danger state in the danger determination, the integrated ECU 4 may store the date and time when the danger determination is performed, in the storage device 6.

The integrated ECU 4 may transmit a history of a result of the danger determination to an external apparatus according to a request from the external apparatus or the like. For example, the integrated ECU 4 may transmit a history of a result of the danger determination to a server of an insurance company that handles a vehicle insurance for the vehicle 2. Thereby, a history of a result of the danger determination, that is, data indicating a timing and frequency at which the vehicle 2 enters to a danger state can be transmitted to the external apparatus. For example, in a case where the data is transmitted to a server of an insurance company, the data can be used by the insurance company to calculate an insurance cost of the vehicle 2. For example, for a driver of the vehicle 2, which is likely to enter a driving scene with a high risk of an accident or a near-miss, an insurance cost can be adjusted to be raised. Thereby, it possible to set an optimum insurance cost according to driving characteristics of the driver.

### Implementation Example by Software

The control blocks of the server 1 and the integrated ECU 4 may be realized by logical circuits (hardware) formed on an integrated circuit (IC chip) or the like, or may be realized by software.

In the latter case, the server 1 and the integrated ECU 4 include a computer that executes instructions of a program as software realizing each function. The computer includes, for example, one or more processors and a computer-readable recording medium which stores the program. The object of one or more embodiments of the present invention is achieved by causing the processor of the computer to read the program from the recording medium and execute the program. As the processor, for example, a central processing unit (CPU) may be used. As the recording medium, in addition to “a non-transitory tangible medium” such as a read only memory (ROM), for example, a tape, a disk, a card, a semiconductor memory, a programmable logical circuit, or the like may be used. In addition, a random access memory (RAM) or the like that loads the program may be further provided. Further, the program may be supplied to the computer via a certain transmission medium (a communication network and broadcast waves) that can transmit the program. One or more embodiments of the present invention may also be realized in a form of a data signal included in a carrier wave in which the program is embodied by electronic transmission.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A control device comprising:
a vehicle data collection unit that sequentially collects vehicle data from a vehicle-mounted device, the vehicle data indicating at least one of a state of a vehicle, a state of a driver of the vehicle, and a situation around the vehicle;
a determination data acquisition unit that acquires determination data which is created based on at least a part of accident vehicle data as the vehicle data collected when an accident or an accident sign operation occurs in the past in a plurality of vehicles;
a danger determination unit that sequentially determines whether or not the vehicle is in a danger state based on the vehicle data and the determination data, the danger state being a state where the accident or the accident sign operation is likely to occur; and
an operation control unit that controls an operation of the vehicle or at least a part of various devices mounted on the vehicle in a case where it is determined that the vehicle is in a danger state.

2. The control device according to claim 1,
wherein the determination data comprises data indicating a range of value of at least a part of parameters of the accident vehicle data, the range of value being a range in which the vehicle is estimated as being likely to enter the danger state, and
wherein the danger determination unit determines that the vehicle is in the danger state in a case where a value of a parameter of the vehicle data is included in the range of value.

3. The control device according to claim 2,
wherein the danger determination unit determines whether or not the vehicle is in the danger state according to, among the parameters of the vehicle data, a number of parameters of the vehicle data each having a value included in the range of value of the same parameter of the determination data.

4. The control device according to claim 1,
wherein the determination data is a prediction model, which is created based on a learned model obtained by inputting at least a part of parameters of the accident vehicle data and performing machine learning of a value of the at least a part of parameters when the accident or the accident sign operation occurs, and
wherein the danger determination unit determines whether or not the vehicle is in the danger state based on a matching rate of values of the parameters included in the vehicle data when the values are input to the prediction model.

5. The control device according to claim 1,
wherein the operation control unit notifies the driver that the vehicle is in the danger state by causing an output device of the various devices to perform outputting.

6. The control device according to claim 1,
wherein the operation control unit controls, as the operation of the vehicle or at least a part of the various devices mounted on the vehicle, an operation of the vehicle or the various devices executed in response to a manipulation related to driving of the driver.

7. The control device according to claim 1, further comprising:
a personal data collection unit that collects personal data related to an individual driver,
wherein the determination data is created based on at least a part of the personal data, and
wherein the danger determination unit sequentially determines whether or not the vehicle is in the danger state based on the vehicle data, the personal data, and the determination data.

8. The control device according to claim 1, further comprising:
a danger operation detection unit that detects, as a danger operation, a specific behavior of the vehicle or the driver indicating the accident or the accident sign operation; and
a transmission unit that transmits, to a server, the accident vehicle data obtained by extracting at least a part of the vehicle data in a case where the danger operation is detected,
wherein the determination data acquisition unit acquires the determination data created by the server.

9. A server that performs communication with the control device according to claim 1, the server comprising:
a server reception unit that receives the accident vehicle data;
a determination data creation unit that creates the determination data based on at least a part of the accident vehicle data; and
a server transmission unit that transmits the determination data to the control device.

10. A safety system comprising:
the control device according to claim 1; and
a server that performs communication with the control device, the server comprising:
a server reception unit that receives the accident vehicle data;
a determination data creation unit that creates the determination data based on at least a part of the accident vehicle data; and
a server transmission unit that transmits the determination data to the control device.

11. A control method of a control device, the control method comprising:
sequentially collecting vehicle data from a vehicle-mounted device, the vehicle data indicating at least one of a state of a vehicle, a state of a driver of the vehicle, and a situation around the vehicle;
creating determination data based on at least a part of accident vehicle data as the vehicle data collected when an accident or an accident sign operation occurs in the past in a plurality of vehicles;
sequentially determining whether or not the vehicle is in a danger state based on the vehicle data and the determination data, the danger state being a state where the accident or the accident sign operation is likely to occur; and
controlling an operation of at least a part of the vehicle in a case where it is determined that the vehicle is in a danger state.
